(19) United States
(12) Patent Application Publication
(10) Pub. No.: US 2014/0278116 A1
(43) Pub. Date: Sep. 18, 2014

(54) FREQUENCY-SPARSE SEISMIC DATA ACQUISITION AND PROCESSING

(71) Applicant: WESTERNGECO L.L.C., HOUSTON, TX (US)

(72) Inventors: DAVID FRASER HALLIDAY, CHERRY HINTON (GB); ROBERT MONTGOMERY LAWS, CAMBRIDGE (GB); JON-FREDRIK HOPPERSTAD, CAMBRIDGE (GB); EVERHARD JOHAN MUIJZERT, GIRTON (GB); EMMANUEL COSTE, HOUSTON, TX (US)

(73) Assignee: WESTERNGECO L.L.C., HOUSTON, TX (US)

(21) Appl. No.: 14/207,105

(22) Filed: Mar. 12, 2014

Related U.S. Application Data
(60) Provisional application No. 61/787,643, filed on Mar. 15, 2013.

(51) Int. Cl. G01V 1/30; G01V 1/04

(52) U.S. Cl. CPC G01V 1/306; G01V 1/04; G01V 1/38
USPC 702/14; 367/15

(57) ABSTRACT

A method includes receiving data representing measurements acquired by seismic sensors in response to energy that is produced by shots of a seismic source. The energy that is produced by the seismic source for each shot includes a plurality of discrete frequencies of discrete frequency bands that are within a frequency range of interest and are separated by at least one excluded frequency or frequency band. The data may be processed to determine at least one characteristic of a geologic structure.

### CROSS-REFERENCE TO RELATED APPLICATION

This application claims the benefit of U.S. Provisional Patent Application Ser. No. 61/787,643 filed Mar. 15, 2013, which is incorporated herein by reference in its entirety.

### BACKGROUND

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and industrial surveys may deploy only one type of sensor, both hydrophones and geophones, and/or other suitable sensor types. A typical measurement acquired by a sensor contains desired signal content (a measured pressure or particle motion, for example) and an unwanted content (or “noise”).

### SUMMARY

The summary is provided to introduce a selection of concepts that are further described below in the detailed description. This summary is not intended to identify key or essential features of the claimed subject matter, nor is it intended to be used as an aid in limiting the scope of the claimed subject matter.

In accordance with an example implementation, a method includes receiving data representing measurements acquired by seismic sensors in response to energy that is produced at least in part by shots of a seismic source. The energy that is produced by the seismic source for each shot includes a plurality of discrete frequency bands that are within a frequency range of interest and are separated by at least one excluded frequency band. The method includes processing the data to determine at least one characteristic of a geologic structure.

In another example implementation, a system includes an interface and a processor. The interface receives data representing measurements acquired by seismic sensors during a towed seismic survey in response to energy produced at least in part by shots of a seismic source. The energy that is produced by the seismic source for each shot includes a plurality of discrete frequency bands that are within a frequency range of interest and are separated by at least one excluded frequency band. The processor processes the data to determine at least one characteristic of a geologic structure.

In another example implementation, an article includes a non-transitory computer readable storage medium that stores instructions that when executed by a computer cause the computer to receive data representing measurements acquired by seismic sensors during a towed seismic survey in response to energy that is produced at least in part by shots of a seismic source. The energy produced by the seismic source for each shot includes a plurality of discrete frequency bands, which are within a frequency range of interest and are separated by at least one excluded frequency band. The instructions when executed by the computer cause the computer to process the data to determine at least one characteristic of a geologic structure.

In yet another example implementation, a method includes performing a survey of a structure using energy that is generated at least in part by shots of an energy source. The method includes using the energy source to generate energy for each shot at a plurality of discrete frequency bands that are within a frequency range of interest and are separated by at least one excluded frequency band.

Advantages and other features will become apparent from the following drawings, description and claims.

### BRIEF DESCRIPTION OF THE DRAWINGS

FIG. 1A is a schematic diagram of a seismic acquisition system according to an example implementation.

FIG. 1B is an illustration of a source array used in a towed seismic survey according to an example implementation.

FIG. 2 is a flow diagram depicting a technique to acquire and process frequency-sparse seismic data according to an example implementation.

FIGS. 3A, 3B, 3C and 3D are illustrations of spectral distributions of source energies according to an example implementation.

FIG. 3E is an illustration of a composite spectral distribution of the source energies according to an example implementation.

FIG. 4 is a flow diagram depicting a technique to acquire and process seismic data using source energies having frequency-interleaved spectral distributions according to an example implementation.

FIG. 5 is a flow diagram depicting a technique to acquire and process seismic data using source energies having selectively excluded source frequency bands for purposes of reducing acquisition time and/or allowing more acquisition time for other source frequencies according to an example implementation.

FIG. 6 is a flow diagram depicting a technique to acquire and process seismic data using source energies having selectively excluded source frequency bands corresponding to a maximum source power consumption, marine life and/or an ambient noise source according to an example implementation.

FIG. 7 is a flow diagram depicting a technique to acquire and process seismic data using selected source frequencies for a frequency-sparse data-based application according to an example implementation.

FIG. 8 is a schematic diagram of a data processing system according to an example implementation.

### DETAILED DESCRIPTION

Systems and techniques are disclosed herein for purposes of conducting a seismic survey using one or more seismic sources that produce energies, which are each continuous in the time domain but are discontinuous in the frequency domain. In particular, the energy generated by a given seismic source, in accordance with example implementations disclosed herein, may be “sparse” in the frequency domain, in that the source energy is distributed in discrete frequency bands that generally collectively span a frequency range of interest (the full seismic frequency range, such as a range between approximately 2 Hertz (Hz) to about 100 Hz, or a subset of the full seismic frequency range, as examples), while not being present in one or more excluded frequencies, or frequency bands, in this range. Due to the frequency-sparse source energy, the seismic sensors acquire frequency-sparse seismic data in the survey; and the frequency-sparse data may be beneficial for certain processing applications, such as source separation, noise suppression, velocity model determination, migration, and so forth, as further discussed herein. Moreover, the frequency-sparse data may be beneficial for other reasons, such as improving survey time allocation efficiency; avoiding “noisy” frequencies; allowing the survey to be conducted in areas sensitive to certain marine life; and so forth, as further discussed herein.

As a more specific example, in accordance with example implementations that are disclosed herein, the seismic source is a towed marine source; and more specifically, the seismic source is a towed marine seismic vibrator, which generates a sweep according to a corresponding source function (a function that controls the time profile and frequency distribution of the sweep). In this manner, although the sweep may be continuous in the time domain, the sweep may not contain all frequencies in the full seismic frequency range. Rather, the sweep may contain selected frequencies or bands of frequencies within the full seismic frequency range, in accordance with example implementations.

In accordance with example implementations that are disclosed herein, interpolation/construction (also called “reconstruction”) may be used to construct seismic data corresponding to a given source for the excluded source frequencies that are absent in the source's energy. As an example, this construction/interpolation may be achieved using frequency-diverse signal processing techniques, which take advantage of the structure that is present in the seismic data. The constructed/interpolated data may then be used in further data processing, which relies on the data associated with the full seismic frequency range. The construction may be performed along the temporal direction, along the spatial direction or simultaneously in both directions, depending on the particular implementation.

As discussed further herein, in accordance with example implementations, a given source function is not merely a narrow frequency band function, but rather, the source function for a given towed seismic source may span the full seismic frequency range. Thus, a given seismic source may be viewed as a multiple frequency band source, where the multiple bands are subset frequency bands within the full seismic frequency range.

Although a towed marine seismic survey is described herein in example implementations, it is understood that the techniques and systems that are disclosed herein may likewise be applied to stationary marine seismic surveys (seabed or ocean bottom cable (OBC)-based surveys, for example). Moreover, the systems and techniques that are disclosed herein may apply to non-seismic imaging acquisition and processing systems. Thus, many implementations are contemplated, which are within the scope of the appended claims.

Referring to FIG. 1A, as an example of a towed survey, a marine-based seismic data acquisition system 10 includes a survey vessel 20, which tows one or more seismic streamers 30 (one exemplary streamer 30 being depicted in FIG. 1A) behind the vessel 20. It is noted that the streamers 30 may be arranged in an array, or spread, in which multiple streamers 30 are towed in approximately the same plane at the same depth. As another non-limiting example, the streamers may be towed at multiple depths, such as in an over/under spread, for example. Moreover, the streamers 30 of the spread may be towed in a coil acquisition configuration and/or at varying depths or slants, depending on the particular implementation.

A given streamer 30 may be several thousand meters long and may contain various support cables (not shown), as well as wiring and/or circuitry (not shown) that may be used to support communication along the streamer 30. In general, the streamer 30 includes a primary cable into which is mounted seismic sensors that record seismic signals. In accordance with example implementations, the streamer 30 contains seismic sensor units 58, each of which contains a multi-component sensor. The multi-component sensor includes a hydrophone and particle motion sensors, in accordance with some implementations. Thus, each sensor unit 58 is capable of detecting a pressure wavefield and at least one component of a particle motion that is associated with acoustic signals that are proximate to the sensor. Examples of particle motions include one or more components of a particle displacement, one or more components (inline (x), crossline (y) and vertical (z) components (see axes 59, for example)) of a particle velocity and one or more components of a particle acceleration.

Depending on the particular implementation, the multi-component sensor may include one or more hydrophones, geophones, particle displacement sensors, particle velocity sensors, accelerometers, pressure gradient sensors, or combinations thereof.

As a more specific example, in accordance with some implementations, a particular multi-component sensor may include a hydrophone for measuring pressure and three orthogonally-aligned accelerometers to measure three corresponding orthogonal components of particle velocity and/or acceleration near the sensor. It is noted that the multi-component sensor may be implemented as a single device (as depicted in FIG. 1A) or may be implemented as a plurality of devices, depending on the particular embodiment of the invention. A particular multi-component sensor may also include pressure gradient sensors, which constitute another type of particle motion sensors. Each pressure gradient sensor measures the change in the pressure wavefield at a particular point with respect to a particular direction.

In addition to the streamers 30 and the survey vessel 20, marine seismic data acquisition system 10 includes at least one seismic source 40, such as the two exemplary seismic sources 40 that are depicted in FIG. 1A. More specifically, the seismic sources 40 may be seismic vibrators that are constructed to generate energy according to sweep-based, or other non-impulsive source functions. In this manner, a given source 40 may generate energy according to a source function in which the frequency of the energy sweeps the full seismic frequency range, although some frequencies may be selectively excluded, as further described herein. It is noted that, in accordance with example implementations, a group of seismic vibrators may be used as a single seismic source.

In accordance with some example implementations, the seismic sources 40 may be coupled to, or towed by, the survey vessel 20. Alternatively, in other implementations, the seismic sources 40 may operate independently of the survey vessel 20, in that the sources 40 may be coupled to other vessels, buoys, autonomous operating vehicles, or may be in fixed positions, as just a few examples. In yet further implementations, multiple vessels may tow the seismic sources 40.

As the seismic streamers 30 are towed, the energies produced by the seismic sources 40 generate acoustic waves 42, which are directed down through a water column 44 into strata 62 and 68 beneath a water bottom surface 24. The acoustic waves 42 are reflected from the various subterranean geological formations, such as an exemplary formation 65 that is depicted in FIG. 1A.

The incident acoustic waves 42 produce corresponding reflected acoustic waves 60, which are sensed by the seismic sensors of the streamer(s) 30. It is noted that the acoustic waves that are received and sensed by the seismic sensors include “up going” pressure waves that propagate to the sensors without reflection, as well as “down going” pressure waves that are produced by reflections of the pressure waves 60 from an air-water boundary, or free surface 31.

The seismic sensors of the streamers 30 generate signals (digital signals, for example), called “traces,” which form the acquired measurements of the pressure wavefield and particle motion. The traces are recorded as seismic data and may be at least partially processed by a signal processing unit 23 that is deployed on the survey vessel 20, in accordance with some implementations and/or may be further processed, in general, by a local or remote data processing system that is generally depicted in FIG. 8 and described below. As an example, a particular multi-component sensor may provide a trace, which corresponds to a measure of a pressure wavefield by its hydrophone; and the sensor may provide (depending on the particular implementation) one or more traces that correspond to one or more components of particle motion.

A goal of the seismic acquisition may be to build up an image of a survey area for purposes of identifying characteristics of subterranean geological formations, such as the example geological formation 65. Subsequent analysis of the representation may reveal probable locations of hydrocarbon deposits in subterranean geological formations. Moreover, the seismic data may be processed to determine characteristics of the geological formation 65, such as the parameters of an elastic model, fluid properties of the formation 65 and the lithology of the formation 65.

In accordance with an example implementation, the seismic sources 40 may be towed in generally parallel paths in a given sail direction 100, as illustrated in FIG. 1B. Moreover, as an example, the seismic sources 40 may be fired according to a path alternating sequence, which is often referred to as a “flip-flop” mode of operation. As depicted in FIG. 1B, for this example, the sources 40 are arranged so that the sources 40-1 and 40-3 are inline and spaced apart by a distance called “D_{1;}” the sources 40-2 and 40-4 are inline in a path that is a distance called “D₂” from the inline path of the sources 40-1 and 40-3 and are spaced apart by the D₁ distance; and the inline positions of the sources 40 are interleaved. As an example, the D₁ distance may be approximately 37.5 meters, and the D₂ distance may be approximately 50 meters. Other D₁ and D₂ distances may be used, in accordance with further implementations.

In accordance with example implementations, a given seismic source 40 may have a corresponding source functions that has a spectral distribution that, in general, spans the full seismic frequency range. The spectral energy of the source function, however, may be discretized into a set of discrete frequencies/frequency bands. In accordance with example implementations, the source functions of the sources 40 may be associated with a different set of frequency bands, and the frequency bands are interleaved with each other, such that the combination of all the source energies continuously or near continuously spans the entire seismic frequency range.

Thus, referring to FIG. 2, in accordance with example implementations, a technique 200 includes towing (block 204) one or more seismic sources in a survey of a geologic structure, and for at least one of the seismic sources, using shots of the source to produce energy. This energy at each shot is characterized by a spectral energy distribution that has energies at discrete frequency bands (or discrete frequencies) in a frequency range of interest, and these discrete frequency bands (or frequencies) of energy are separated by at least one intervening frequency band (or frequency) that has excluded spectral energy, pursuant to block 208. The technique 200 includes acquiring (block 212) frequency-sparse data representing energy measurements due to interaction of the incident energy with the geologic structure and processing (block 216) the data to determine at least one characteristic of the geologic structure.

In accordance with example implementations, the frequency-sparse data represents measurements acquired by the seismic sensors in response to a plurality of shots. Depending on the particular implementation, the energy generated by each of the shots (from a given seismic source or group of seismic sources) may vary from shot to shot or may not change from shot to shot. Moreover, in accordance with further example implementations, the data may represent measurements of energy generated by interfering seismic sources (simultaneously or near-simultaneously fired seismic sources, for example); and the energy may change across these sources.

In accordance with example implementations, the seismic sources 40 may be simultaneously activated. FIGS. 3A, 3B, 3C and 3D depict corresponding spectral energies 300, 304, 308, 312 and 316 generated by the seismic sources 40-1, 40-2, 40-3 and 40-4 (see FIG. 1B), respectively, in accordance with an example implementation. As can be seen from these figures, the energy generated by each source 40 contains spectral energy that is distributed in discrete frequency bands. The spectral frequency bands for each source 40 form part of a composite spectral energy (FIG. 3E) such that all of the bands interleave with each other to span the entire full seismic frequency range. Because the frequency bands are complementary, data from the sources 40 may be acquired simultaneously.

After the data acquisition, the data may be processed to separate the energy according to the sources 40 using one of a number of techniques, depending on the particular implementation. For example, in accordance with some implementations, bandpass filtering may be employed, such that the data for a particular source 40 may be isolated using bandpass filters, which target the frequency bands of the associated source function. As another example, in accordance with some implementations, source separation may be performed by deconvolving the simultaneously-acquired data by each sweep in turn.

The above-described source separation produces frequency-sparse data that corresponds to each of the seismic sources 40-1, 40-2, 40-3 and 40-4. After the separation, it may be desirable to process the sparse data as it is, without further construction/interpolation of the data that corresponds to the missing frequencies. For example, in accordance with some implementations, the frequency-sparse data may be processed through a relatively simple processing sequence to generate a seismic image in a relatively short period of time. However, in accordance with other implementations, construction/interpolation techniques may be applied so that the data processed represents the full seismic frequency range.

In accordance with example implementations, construction/interpolation may be performed by taking advantage of the structure within the seismic data and by using a data dependent approach, which uses a set of basis functions to construct the data at frequencies that were not acquired. For example, in accordance with some implementations, interpolation may be achieved using a matching pursuit technique, such as the matching pursuit technique described in Vassallo, M., Özbek, A., Özdemir, K., and Eggenberger, K., 2010, CROSSLINE WAVEFIELD RECONSTRUCTION FROM MULTICOMPONENT STREAMER DATA: PART 1—MULTICHANNEL INTERPOLATION BY MATCHING PURSUIT (MIMAP) USING PRESSURE AND ITS CROSSLINE GRADIENT, Geophysics 75, 53-67. As another example, interpolation may be used by employing a method that uses a multiple frequency basis function, such as the frequency-diverse technique that is disclosed in U.S. Patent Application Publication No. US 2013/0182533 A1, entitled, “Attenuating Noise Acquired in an Energy Measurement,” (herein referred to as the “'533 patent application”).

When construction/interpolation is used to construct the data for the missing frequencies, a seismic processing sequence that relies on the full seismic frequency range may then be applied.

In addition to being used in conjunction with simultaneously-activated seismic sources in the same survey, the above-described approach may be used to suppress interference due to nearby surveys by having the surveys use two different sets of frequency-sparse sweeps. The above-described technique may also be used to suppress residual shot noise in the same survey by alternating the frequency bands of seismic source(s) of the survey from one shot to the next.

Thus, referring to FIG. 4, in accordance with example implementations, a technique 400 includes generating a plurality of seismic source shots (shots associated with simultaneously-activated sources; shots associated with different surveys; successive shots of the same survey; and so forth) and interleaving (block 408) frequency bands (or frequencies) of energies that are associated with the shots. The technique 400 may further include acquiring (block 412) data representing the shots and processing the data to perform source separation, pursuant to block 416. The technique 400 includes processing the data to construct/interpolate data for the excluded frequency bands, pursuant to block 420. According to the technique 400, the constructed and acquired seismic data may then be further processed, pursuant to block 424.

In accordance with some example implementations, a sweep for a given source or sources may be designed to enhance the low frequency content of the acquired seismic data. For purposes of designing a sweep for such low frequency content enhancement, a number of factors may be taken into account. In this manner, the factors may include selection of the desired low frequencies to be part of the acquired seismic data, as well as selection of the frequencies to be excluded and later constructed.

In accordance with some implementations, the excluded frequency range is constructed to be sufficiently small enough so that the spectral content for the excluded frequency range may be constructed/interpolated to a satisfactory level. As a more specific example, in accordance with example implementations, frequencies from approximately two to four Hz may be excluded, which allows a relatively longer time to be spent sweeping from one to two Hz. Due to the relatively smooth behavior of seismic data at such relatively low frequencies, it is likely that data for the excluded range may be constructed/interpolated at an acceptable accuracy level.

As an example, after data acquisition, construction/interpolation of the data for the missing frequency(ies) may be performed using a frequency-diverse interpolation method, such as a modification of the frequency-diverse deghosting method that is discussed in the '533 patent application. This frequency-diverse deghosting method “fills in” the ghost notch by using a multiple frequency basis function; and in a similar way, the technique may be used to construct/interpolate data for the excluded frequencies.

After the construction/interpolation process, the processing of the data that corresponds to the full seismic frequency range may then continue as desired. The enhanced spectral content for the low frequency may be particularly beneficial for acoustic impedance inversions; stable full waveform inversion (such as the inversion discussed in Virieux, J., and Operto, S., 2009, AN OVERVIEW OF FULL WAVEFORM INVERSION IN EXPLORATION GEOPHYSICS, Geophysics, Vol. 74, No. 6, WCC1-WCC26); and other such operations.

Thus, referring to FIG. 5, in accordance with an example implementation, a technique 500 includes activating (block 504) one or more seismic sources as part of a towed survey of a geologic formation. Pursuant to the technique 500, one or more source frequency bands are selectively excluded (block 508) to reduce the acquisition time and/or allow time for one or more other source frequency bands. The acquired seismic data representing the seismic measurements is acquired, pursuant to block 516, and the acquired seismic data is processed (block 520) to construct/interpolate the data for the missing frequency band(s). Next, the constructed/interpolated and acquired seismic data may be further processed, pursuant to block 524.

Source frequencies may be excluded for other reasons, in accordance with further implementations. For example, the power demand of a marine vibrator typically varies as a function of its frequency. In this manner, the vibrator may have a peak power demand, or consumption, at a relatively low frequency, at which the vibrator is not stroke-limited. Such a frequency or range of frequencies, which correspond to the peak power consumption may be targeted so that these source frequencies may be excluded by the vibrator and which may reduce the power consumption of the vibrator considerably, in accordance with example implementations. It is noted that the interpolation/construction of the data for the excluded frequency band follows the same steps as above as for a low frequency source. In accordance with some implementations, the two approaches may be combined: the lower frequencies may be enhanced while the power consumption of the vibrator is reduced. Such an approach may involve applying a frequency-sparse source function that has multiple frequency gaps.

The source function may omit one or more frequencies that are associated with marine life, in accordance with further example implementations. In this manner, in an area that is particularly sensitive to marine life, a number of discrete frequencies may be avoided (frequencies associated with whale or other marine life communications, for example), particularly if the alternative is to forego the seismic survey. As yet another example, one or more frequencies may be excluded, which correspond to ambient noise sources. As examples, such ambient noise sources may be tonal rig noises; noises emitted by the survey vessel or equipment; noises generated by nearby interfere ring surveys; and so forth.

In accordance with some implementations, a search may be made for the relative “low points” in the ambient noise spectrum so that these “low points” may be selected as the discrete source emission frequencies. This selection may be varied dynamically as the survey progresses (e.g., the ambient noise spectrum may be monitored by a frequency spectrum analyzer as the survey processes to identify the low points), in accordance with example implementations.

Thus, referring to FIG. 6, in accordance with example implementations, a technique 600 includes activating (block 604) one or more seismic sources and excluding (block 608) one or more source frequency bands, which correspond to a maximum source power consumption, marine life, and/or one or more frequency bands that do not originate with the seismic source(s). Data representing seismic measurements are acquired, pursuant to block 612, and the data is processed, pursuant to block 616, to construct/interpolate the data for the excluded frequency band(s). Moreover, pursuant to the technique 600, the constructed/interpolated and acquired seismic data are further processed, pursuant to block 620.

In general, in accordance with example implementations, the source function design relies on knowledge of the data processing flow that follows the acquisition. For example, for the case of frequency-domain full waveform inversion, such as the full waveform inversion discussed in Sirgue, L., and Pratt, R. G., 2004, EFFICIENT WAVEFORM INVERSION AND IMAGING: A STRATEGY FOR SELECTING TEMPORAL FREQUENCIES, Geophysics, Vol. 69, 231-248, a relatively few discrete frequencies are processed to produce a detailed velocity model. By designing one or more source functions that emit the discrete frequencies to be used in the inversion process to produce the velocity model, the signal-to-noise ratio at these discrete frequencies may be improved. Thus, the time that would have otherwise been spent sweeping all the other frequencies may instead be allocated to the selected, discrete frequencies.

Moreover, in accordance with example implementations, a given source sweep that is discrete at relatively low frequencies may be continuous at higher frequencies. In this manner, in accordance with example implementations, a given source function may be relatively sparse in frequency for frequencies below approximately ten Hz and may be continuous in a range above ten Hz to the upper limit (a frequency between approximately 90 to 100 Hz, for example) of the seismic spectrum. This allows the determination of the velocity model from the spectral energy provided by the discrete frequency bands using, for example, frequency-domain full waveform inversion and the use of the velocity model in processing models that are applied to the data corresponding to the portion of the spectrum above ten Hz.

Although full waveform inversion is mentioned herein, it is noted that in accordance with example implementations, other applications may take advantage of the lower frequency sparse data. For example, seismic migration may be used to determine starting models for the full waveform inversion process. The frequency-sparse data may be processed to achieve the desired result, as the seismic wavelet may be adequate even with the discrete frequency samples. If inadequate, the above-described frequency diverse construction/interpolation techniques may be used to reconstruct the seismic data for the excluded frequencies.

Thus, referring to FIG. 7, in accordance with example implementations, a technique 700 includes activating (block 704) one or more seismic sources and using (block 708) one or more discrete source frequencies below approximately twenty Hz in the survey. Pursuant to the technique 700, a continuous range of source frequencies above twenty Hz to a maximum frequency of interest (the upper or maximum seismic frequency, for example) may be used, in accordance with example implementations. The technique 700 includes acquiring (block 716) data representing the seismic measurements and processing (block 720) the data in an application that uses the sparse low frequency data without further construction/interpolation of the data for the excluded low frequency band(s).

In accordance with some implementations, the seismic source(s) may emit a tone or tones continuously at a set of chosen discrete frequencies. Because of the continuous nature of the source activation, the survey system's recording system may record essentially the amplitude and phase at each of those frequencies, rather than recording data pertaining to other aspects of the entire waveform. Thus, using sparse source frequencies, a relatively small amount of data may be recorded, as compared to, for example, recording data indicative of the entire waveform.

As discussed herein, data may be constructed for the excluded source frequencies prior to further processing. This construction may be applied to pre-stack seismic data, such as, for example, common source gathers, common receiver gathers, common offset gathers and so forth. In accordance with some implementations, the frequency construction may be carried out after the data has been sorted into a common-midpoint gather, corrected for NMO and stacked. The stacked common midpoint gather may be filtered prior to construction to remove spurious frequencies, which are introduced by smearing in the NMO correction, in accordance with example implementations.

Referring to FIG. 8, in accordance with some implementations, a machine, such as a data processing system 820, may contain a processor 850 for purposes of processing the frequency-sparse data.

In accordance with some implementations, the processor 850 may be formed from one or more microprocessors and/or microprocessor processing cores. In general, the processor 850 is a general purpose processor, and may be formed from, depending on the particular implementation, one or multiple central processing units (CPUs), or application specific integrated circuits (ASICs), field programmable gate arrays (FPGAs), programmable logic devices (PLDs), or other appropriate devices, as can be appreciated by the skilled artisan. As a non-limiting example, the processor 850 may be part of the circuitry 23 (see FIG. 1A) on the vessel 20, or may be disposed at a remote site. Moreover, the data processing system 820 may be a distributed processing system, in accordance with further implementations.

As depicted in FIG. 8, the processor 850 may be coupled to a communication interface 860 for purposes of receiving data 822, which represents frequency-sparse data acquired by seismic sensors and generally represents data resulting from the interaction of source energy with a geologic structure, where the source energy is the result of the application of one or more frequency-sparse source functions, as described herein. As examples, the communication interface 860 may be a Universal Serial Bus (USB) interface, a network interface, a removable media interface (a flash card, CD-ROM interface, etc.) or a magnetic storage interface (an Intelligent Device Electronics (IDE)-compliant interface or Small Computer System Interface (SCSI)-compliant interface, as non-limiting examples). Thus, the communication interface 860 may take on numerous forms, depending on the particular implementation.

In accordance with some implementations, the processor 850 is coupled to a memory 840 that stores program instructions 844, which when executed by the processor 850, may cause the processor 850 to perform various tasks of one or more of the techniques that are disclosed herein, such as the techniques 200, 400, 500, 600 and/or 700, as examples.

As a non-limiting example, in accordance with some implementations, the instructions 844, when executed by the processor 850, may cause the processor 850 to receive frequency-sparse data (e.g., pressure and particle motion data), which may be acquired in tow or may be acquired by a stationary cable or other sensor arrays, as examples. The instructions 844, when executed by the processor 850 may further cause the processor 850 to process the data to determine at least one characteristic of a geologic structure.

In general, the memory 840 is a non-transitory storage medium and may take on numerous forms, such as (as non-limiting examples) semiconductor storage, magnetic storage, optical storage, phase change memory storage, capacitor-based storage, and so forth, depending on the particular implementation. Moreover, the memory 840 may be formed from more than one of these non-transitory storage mediums, in accordance with further implementations. When executing one or more of the program instructions 844, the processor 850 may store preliminary, intermediate and/or final results obtained via the execution of the instructions 844 as data 848 that may be stored in the memory 840.

It is noted that the data processing system 820 is merely an example of one out of many possible architectures, in accordance with the techniques and systems that are disclosed herein. Moreover, the data processing system 820 is represented in a simplified form, as the processing system 820 may have various other components (a display to display initial, intermediate and/or final results of the system's processing, as non-limiting examples), as can be appreciated by the skilled artisan.

Other variations are contemplated, which are within the scope of the appended claims. For example, the systems and techniques that are disclosed herein may be applied to energy measurement acquisitions systems, other than seismic acquisition systems. For example, the techniques and systems that are disclosed herein may be applied to non-seismic-based geophysical survey systems, as electromagnetic or magnetotelluric-based acquisition systems, in accordance with further implementations. The techniques and systems that are disclosed herein may also be applied to energy measurement acquisition systems, other than systems that are used to explore geologic regions. Thus, although the surveyed target structure of interest described herein is a geologic structure, the target structure may be a non-geologic structure (human tissue, a surface structure, and so forth), in accordance with further implementations.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
receiving data representing measurements acquired by seismic sensors in response to energy produced at least in part by shots of a seismic source, wherein the energy produced by the seismic source at each shot comprises a plurality of discrete frequencies or discrete frequency bands within a frequency range of interest separated by at least one excluded frequency or frequency band; and
processing the data to determine at least one characteristic of a geologic structure.

2. The method of claim 1, wherein receiving the data comprises receiving data representing measurements acquired by the seismic sensors in response to a plurality of shots.

3. The method of claim 2, wherein the energy generated by each of the shots changes from shot to shot.

4. The method of claim 2, wherein the energy generated by the shots does not change from shot to shot.

5. The method of claim 2, wherein the energy is generated by interfering seismic sources and the energy changes across the sources.

6. The method of claim 2, wherein the shots comprise shots associated with at least two surveys.

7. The method of claim 1, wherein processing the data comprises constructing data associated with the at least one excluded frequency or frequency band.

8. The method of claim 1, wherein:
the at least one excluded frequency or frequency band comprises a plurality of frequencies below twenty Hertz; and
the discrete frequencies or frequency bands of the energy comprise a continuous frequency band beginning at a frequency near twenty Hertz and ending at a maximum frequency of interest.

9. The method of claim 1, wherein the at least one excluded frequency or frequency band comprises a frequency sensitive to marine life or a frequency associated with noise not originating from the seismic source.

10. The method of claim 1, wherein processing the data comprises:
sorting the data into gathers;
stacking the gathers; and
constructing data for the at least one omitted frequency after the stacking.

11. A system comprising:
an interface to receive data representing measurements acquired by seismic sensors during a towed seismic survey in response to energy produced at least in part by a seismic source, wherein the energy produced by the seismic source at each shot comprises a plurality of discrete frequencies or discrete frequency bands within a frequency range of interest separated by at least one excluded frequency or frequency band; and
a processor to process the data to determine at least one characteristic of a geologic structure.

12. The system of claim 11, wherein the processor is adapted to process the data to perform bandpass filtering to target the discrete frequency bands.

13. The system of claim 11, wherein the processor is adapted to process the data in an application that uses a spectral range associated with the at least one excluded frequency or frequency band without further construction or interpolation of data corresponding to the at least one excluded frequency or frequency band.

14. The system of claim 13, wherein performing the application comprises determining a velocity model or performing migration.

15. An article comprising a non-transitory computer readable storage medium storing instructions that when executed by a computer cause the computer to:
receive data representing measurements acquired by seismic sensors during a towed seismic survey in response to energy produced at least in part by a seismic source, wherein the energy produced by the seismic source at each shot comprises a plurality of discrete frequencies or discrete frequency bands within a frequency range of interest separated by at least one excluded frequency or frequency band; and
process the data to determine at least one characteristic of a geologic structure.

16. A method comprising:
performing a survey of a structure using energy generated at least in part by an energy source; and
using the energy source to generate energy for the survey at a plurality of discrete frequencies or frequency bands within a frequency range of interest separated by at least one excluded frequency or frequency band.

17. The method of claim 16, wherein the survey comprises a survey of a geologic structure, and using the energy source comprises towing a vibrator-based source.

18. The method of claim 16, wherein:
receiving the data comprises receiving data representing measurements acquired by the seismic sensors in response to a plurality of shots; and
the energy varies from shot to shot.

19. The method of claim 16, wherein:
receiving the data comprises receiving data representing measurements acquired by the seismic sensors in response to a plurality of shots; and
the energy does not vary from shot to shot.

20. The method of claim 16, wherein the energy is generated by interfering seismic sources and the energy changes across the sources.

21. The method of claim 16, wherein:
the at least one excluded frequency or frequency band comprises a plurality of frequencies below twenty Hertz; and
the discrete frequency or frequency bands of the energy comprise a continuous frequency band beginning at a frequency near twenty Hertz and ending at a maximum frequency of interest.

22. The method of claim 16, wherein the at least one excluded frequency or frequency band comprises a frequency sensitive to marine life or a frequency associated with noise not originating from the source.
